(19) United States
(12) Patent Application Publication
(10) Pub. No.: US 2016/0063493 A1
(43) Pub. Date: Mar. 3, 2016

(54) SYSTEM AND METHOD FOR PERFORMING PAYMENT AUTHORIZATION VERIFICATION USING GEOLOCATION DATA

(71) Applicant: MASTERCARD INTERNATIONAL INCORPORATED, Purchase, NY (US)

(72) Inventor: Justin X. Howe, Oakdale, NY (US)

(73) Assignee: MASTERCARD INTERNATIONAL INCORPORATED, Purchase, NY (US)

(21) Appl. No.: 14/476,225

(22) Filed: Sep. 3, 2014

(51) Int. Cl. G06Q 20/40; G06Q 20/32; G06Q 20/34

(52) U.S. Cl. CPC G06Q 20/401; G06Q 20/34; G06Q 20/322

(57) ABSTRACT

A computer implemented system and method for estimating and verifying a characteristic of a billing address of a payment card including receiving mobile phone and payment card number data from a cardholder. Geolocation data associated with the mobile phone is collected at a predetermined time after cardholder permission to access such data has been granted. Once received, a characteristic of an address associated with the geolocation data is estimated and submitted along with the payment card number to an address verification system for verifying the validity of the characteristic of the address.

### CROSS-REFERENCE TO RELATED APPLICATIONS

None.

### FIELD OF INVENTION

The present disclosure relates to systems and methods for determining billing address information of a payment card, and more specifically, to systems and methods for determining at least a billing postal code of a payment card via geolocation information obtained through a personal computing device of a cardholder.

### BACKGROUND

The ever-improving capabilities of personal computing devices (e.g. mobile phones) and prevalence of online retailers has led to a significant increase in the sale of goods and services initiated through these devices (i.e. “mCommerce”). These transactions may be conducted by consumers accessing merchant-specific websites via the internet, or by consumers downloading merchant-specific software applications onto their mobile devices for carrying out purchases. While providing a level of convenience to the consumer, a hindrance of these types of mobile device-based transactions is tied to the inherent drawbacks of mobile computing devices in general, including their limited display capabilities and a lack of full-size keyboards. Accordingly, aspects of these transactions, including the entry of data by the consumer (e.g. payment card information and accompanying billing address information for card verification purposes) may be cumbersome and time consuming, ultimately deterring some individuals from carrying out transactions on their mobile devices.

Systems and methods for streamlining payment card-based transactions performed on mobile devices, while maintaining adequate protection of both merchants and consumers, are desired.

### SUMMARY

In one embodiment of the present disclosure, a computer implemented method for estimating and verifying a characteristic of a billing address of a payment card is provided. The method includes the steps of a merchant computer system receiving a payment card number provided by a cardholder. The merchant computer system requests permission to access geolocation data associated with a personal computing device (e.g. a mobile phone) of the cardholder. If permission is granted, the system requests geolocation data associated with the personal computing device at some predetermined future time. For example, the request may be made at an hour when the cardholder is predicted to be at their home or residence. This geolocation data is received from the personal computing device and stored. In another embodiment, the request for geolocation data may include requesting previously-stored historical geolocation data associated with the personal computing device. From this geolocation data, an estimated characteristic of an address associated with the geolocation data (e.g. a postal code) is determined. This data may be submitted to an address verification system (AVS) for verifying an in-progress transaction, or to pre-empt authorization declines in the future.

In another embodiment, a computer implemented method for estimating and verifying a characteristic of a billing address of a payment card includes the steps of periodically determining a geolocation of a personal computing device associated with the payment card holder. This geolocation data is stored in a historical database. The geolocation data may be analyzed in order to estimate an address characteristic (e.g. a postal code). This estimated address characteristic and a payment card number may be submitted to an address verification system.

According to another embodiment, a method for estimating and verifying a characteristic of a billing address of a payment card performed by a card network is provided. The method includes receiving a customer payment card number and geolocation data associated with a personal computing device of a customer from a merchant. An address characteristic from the geolocation data of the personal computing device (e.g. a mobile phone) is identified. The address characteristic and the payment card number are transmitted to a payment card issuer associated with the payment card for performing an account status inquiry.

### BRIEF DESCRIPTION OF THE DRAWINGS

FIG. 1 illustrates a system architecture within which some embodiments of the present disclosure may be implemented.

FIG. 2 is a functional block diagram of a merchant or managing computer system in accordance with an exemplary embodiment of the present disclosure.

FIG. 3 illustrates a process flow diagram for acquiring and verifying a characteristic of a billing address of a payment card according to an embodiment of the present disclosure.

FIG. 4 illustrates a process flow diagram of an exemplary process for acquiring and verifying a characteristic of a billing address of a payment card according to an embodiment of the present disclosure.

FIG. 5 illustrates a process flow diagram of another exemplary process for acquiring and verifying a characteristic of a billing address of a payment card according to an embodiment of the present disclosure.

FIG. 6 illustrates a data flow diagram for acquiring and verifying a characteristic of a billing address of a payment card according to an embodiment of the present disclosure.

### DETAILED DESCRIPTION

It is to be understood that the figures and descriptions of the present disclosure have been simplified to illustrate elements that are relevant for a clear understanding of the embodiments described herein, while eliminating, for purposes of clarity, many other elements found in computing systems and wireless communication devices, such as mobile telephones or smartphones communicating with one or more remote computers or servers via a local, internet, cellular or satellite networks, as well as computer systems or mobile telephones running native or web-based applications or other software. However, because such elements are well known in the art, and because they do not facilitate a better understanding of the present invention, a discussion of such elements is not provided herein. The disclosure herein is directed to all such variations and modifications known to those skilled in the art.

A “payment account processing system”, “payment card processing system” or “credit card processing network” or “card network”, such as the MasterCard network exists, allowing consumers to use payment cards, or payment accounts, issued by a variety of issuers to shop at a variety of merchants. With this type of payment account or payment card, an account issuer or attribute provider, such as a bank, extends credit to a customer to purchase products or services. When a customer makes a purchase from an approved merchant, the account or card number and amount of the purchase, along with other relevant information, are transmitted via the processing network to a processing center, which verifies that the card has not been reported lost or stolen and that the card's credit limit has not been exceeded. In some cases, the customer's signature is also verified, a personal identification number is required or other user authentication mechanisms are imposed. The customer is required to repay the bank for the purchases, generally on a monthly basis. Typically, the customer incurs a finance charge for instance, if the bank is not fully repaid by the due date. The account or card issuer or attribute provider may also charge an annual fee. The payment card is a card that can be presented (on-line or in-person) by the cardholder (i.e., customer) to a merchant in order to make a payment. By way of example, and without limiting the generality of the foregoing, a payment card can be a credit card, debit card, charge card, stored-value card, or prepaid card or nearly any other type of financial transaction card. Payment accounts, as described herein, include any and all forms of non-card, cashless payments, including, for example, mobile, digital wallet, key fob, or direct carrier billing payments.

It is noted that as used herein, the term “customer”, “cardholder,” “card user,” and/or “card recipient” can be used interchangeably and can include any user who holds a payment card for making purchases of goods and/or services. References to cardholders, payment cards, and the like should also be understood to include users of any type of non-card, cashless payment account as described above. Further, as used herein in, the term “issuer” or “attribute provider” can include, for example, a financial institution (i.e., bank) issuing a card, a merchant issuing a merchant specific card, a stand-in processor configured to act on-behalf of the card-issuer, or any other suitable institution configured to issue a payment card. As used herein, the term “transaction acquirer” can include, for example, a merchant, a merchant terminal, an automated teller machine (ATM), or any other suitable institution or device configured to initiate a financial transaction per the request of the customer or cardholder.

As used herein, the term “processor” broadly refers to and is not limited to a single- or multi-core general purpose processor, a special purpose processor, a conventional processor, a Graphics Processing Unit (GPU), an Applications Processing Unit (APU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

Many online retailers would prefer to simplify the processes of completing electronic customer orders, encouraging greater sales via increasing the ease at which these transactions may be performed. One mechanism to accomplish this goal includes limiting the amount of data a cardholder must enter to complete an electronic transaction. However, ensuring adequate protection of both the merchant as well as victims of payment card theft from fraudulent transactions is also a priority. The collection of customer data can be critical for providing this protection. For example, most domestic retailers utilize the Address Verification System (AVS) for protecting against payment card fraud. The AVS is used to verify the billing address of an individual claiming to own a payment card. As will be understood by one of ordinary skill in the art, the system operates in response to an authorization request initiated by a merchant, and compares the billing address (or a portion of the billing address) of the payment card provided by a customer or alleged cardholder, with the billing address associated with the payment card on file with the card issuer or issuing bank. The issuer returns the results of this comparison, along with other account status information, to the merchant for final approval or denial of a given transaction.

Disclosed herein are processor-executable methods, computing systems, and related processing for estimating and verifying a characteristic of a billing address of a card without requiring the cardholder to input this information. In this way, existing AVS operations may still be performed, ensuring protection of both merchants and would-be victims of fraud, while expediting the purchasing process. One exemplary method includes the steps of receiving a mobile phone number and a payment card number of the cardholder via a merchant computer system (e.g. a merchant-specific software application running on a mobile phone or an internet website). The merchant computer system may request permission from the cardholder to access geolocation data (e.g. latitude and longitude data) associated with the location of the mobile phone of the cardholder. At a predetermined time after permission to access geolocation data has been granted, the system may poll the mobile phone, requesting its geolocation. This geolocation data may be obtained, for example via the phone's global positioning system (GPS). In one exemplary embodiment, a request for geolocation data may be made at an hour when the cardholder is deemed likely to be at their home residence (e.g. at 3:00 AM). This geolocation data is received and stored by the merchant computer system. In another embodiment, the request for geolocation data may include requesting previously-stored historic geolocation data associated with the mobile phone.

Using geocoding techniques, and more specifically, reverse geocoding techniques, an address characteristic (e.g. a postal code) may be generated from this geolocation data. As will be understood by one of ordinary skill in the art, reverse geocoding operations include estimating all or part of a standardized address from geographical coordinates (i.e. a geolocation). These operations may be accomplished by accessing shapefiles (e.g. ESRI shapefiles) and other geographic data resources. Reverse geocoding operations may be performed by the merchant computer system, or may be performed by third party service providers, without departing from the scope of the present disclosure. The generated address characteristic (e.g. a postal code) may be submitted to the AVS by the merchant computer system for verifying an in-progress transaction, or to pre-empt authorization declines of future transactions. It should be understood that the natural delay associated with online or remote purchases (i.e. ordered goods are not immediately provided or shipped to the purchaser) provides a window of opportunity to perform the above-described geolocation identification and address verification processes. In this manner, the system provides timely verification for such merchants without requiring additional actions by the cardholder while still utilizing the AVS used in many payment card transactions.

In another embodiment, a merchant computer system may request (e.g. through a website or mobile application interface) the input of a payment card number and a mobile phone number of cardholder prior to any attempt at completing a specific transaction or sale. For example, during an application or website registration process, a cardholder may be required to enter this information. Once entered, and permission given to access geolocation data of the mobile phone, a merchant or managing computer system may begin to track the geolocation of the mobile phone via periodic inquires. The results of these inquiries may be stored, and a historic database of geolocations generated for the mobile phone.

A remote server or managing merchant computer system according to embodiments of the present disclosure may be programmed to receive (e.g. from a customer's mobile phone) customer identification data, payment card data, mobile phone numbers, geolocation data and associated date and time data generated by the mobile phone. Once received, this data may be processed, which may include the steps of identifying, classifying and storing the received data. For example, any geolocation data may be identified and classified accordingly. This may include identifying the format in which the geolocation data has been transmitted/received. It is envisioned that geolocation data received from customer mobile phones may take on differing or non-standardized forms (e.g. not in the form of conventional latitude and longitude coordinates). Accordingly, received and identified geolocation data may be normalized, or converted, to any suitable standard format. Normalized geolocation data may be stored (e.g. in one or more databases) along with the received customer identification data, mobile phone number, and payment card information.

From the geolocation data on this database, the merchant computer system may estimate a predominant address characteristic. For example, a predominant geolocation regularly recorded during early morning hours may be inferred as corresponding to a residency of the cardholder (and thus, the billing address of the payment card). Once an estimated address characteristic is determined, it is stored in a database and associated with a cardholder. This information may be used for verifying any future cardholder transactions through the AVS, as set forth above. The database may be continuously updated, and historic geolocation data monitored in order to identify, for example, an apparent relocation of the cardholder. It should be understood that embodiments of the present disclosure improve payment card transaction security, as a fraudulent purchaser in possession of a correct billing postal code associated with the payment card may still be prevented from successfully completing a transaction, as the geolocation data captured from a mobile phone utilized by the fraudulent purchaser is unlikely to correspond to a billing address characteristic of the payment card.

While embodiments of the present disclosure describe a merchant or a merchant computer system performing the steps of geolocation data gathering and reverse geocoding, it should be understood that these operations may be sourced from one or more independent service providers, an associated card network or card issuer, or by any other means without departing from the scope of the present disclosure.

In another exemplary embodiment of the present disclosure, a merchant computer system receives payment card information (e.g. a payment card number) from an existing or potential customer. This information may be generated from a new purchase order received from a customer, or from a new customer account registration (e.g. a customer installing a merchant application on their mobile phone and inputting their payment card information for future transactions). In response to receiving the customer payment card information, the merchant computer system requests the mobile phone number of the cardholder, as well as permission to access geolocation data from customer's mobile phone.

At any time after receiving permission, the merchant computer system may acquire geolocation data associated with the customer's mobile phone one or more times. This may include the generation of the above-described historic geolocation database. The merchant computer system may transmit the payment card number and geolocation data to the card network (e.g. MasterCard) associated with the payment card. The card network may, either internally, or through outside resources, identify an address characteristic (e.g. a postal code) from the geolocation data. The card network may transmit this address characteristic and the payment card number to the payment card issuer (e.g. an issuing bank), for performing an Account Status Inquiry (ASI). As will be understood by one of ordinary skill in the art, an ASI, or AVS inquiry, is a request for account information made through the AVS which is not tied to a particular transaction and does not affect the funds availability of the payment account in question. The merchant computer system receives the results of the ASI, including either a positive or negative status response from the issuer. In this way, embodiments of the present disclosure include systems and methods for determining address characteristic validity prior to the occurrence of a purchase transaction. Accordingly, payment card denials for address-related deficiencies can be preemptively avoided. Moreover, as will be understood by one of ordinary skill in the art, an AVS ASI inquiry not tied to a particular transaction is more cost effective than submitting an AVS authorization record for a particular purchase transaction.

The desired or target address characteristics determined from the geolocation data according to embodiments of the present disclosure may be dictated by which version of the AVS has been adopted by the merchant. More specifically, the AVS may be tasked with verifying only a postal code, a full numerical address, or may require an exact textual match of an entire address. Accordingly, it is envisioned that embodiments of the present disclosure may utilize acquired geolocation data to generate not only postal codes, but more specific address information including, but not limited to city, street and home or building numbers. This additional information may be submitted to the AVS for address verification processing as described above.

While embodiments of the present disclosure have been described herein as utilizing GPS data received from a mobile phone, it should be understood that embodiments may utilize other methods to calculate the location of the phone or personal computing device of a customer. For example, triangulation or multilateration of radio signals between multiple radio towers of a phone network, GSM localization, WiFi location positioning (as offered, for example, by Skyhook Wireless), or any other suitable means may be used. Moreover, it is envisioned that transactions completed using personal computers or other IP devices may also be subject to the methods described herein, as the general locations of these devices may be determined by, for example, analysis of associated IP addresses.

While the above computations have been described as being performed on a remote server or merchant computer system It should be understood that some or all of these processes may be performed on the customer's mobile phone or personal computing device via software running thereon, and the results of the processing transmitted to the merchant computer system for storage and future access. Moreover, data transmissions between the customer's mobile phone and the merchant computer system may be initiated by the customer's mobile phone (e.g. by the application running thereon) e.g. automatically, or may be initiated (e.g. by a request) sent by the merchant computer system to the participant device requesting geolocation data.

In still other embodiments, alternative address verification methods according to embodiments of the present disclosure may not utilize standard AVS processing. For example, if a merchant computing system is in possession of a previously-verified billing address or address characteristic, such as one input by a customer during a prior purchase, a comparison may be made between that billing address (or characteristic) and the address characteristic estimated from geolocation data associated with the customer's personal computing device. If the address characteristics match, a merchant computing system may forgo traditional AVS processing. Likewise, embodiments may still proceed with AVS processing even after this internal verification step is performed.

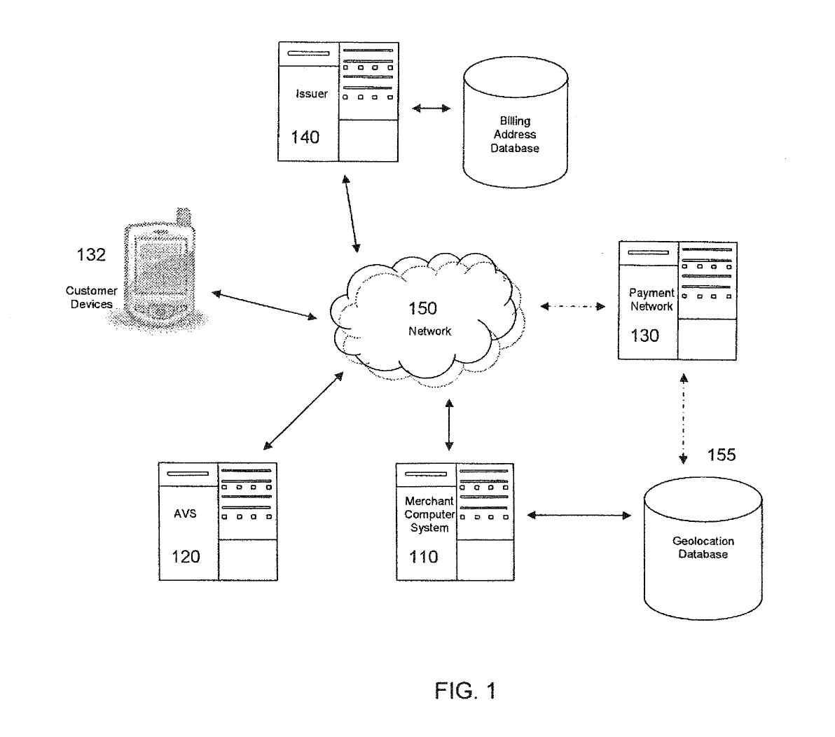

Referring now to FIG. 1, there is shown a high-level diagram illustrating an exemplary system for acquiring and verifying a characteristic of a billing address of a payment card according to an embodiment of the present disclosure. As shown in FIG. 1, system 100 includes a remote server embodied as a managing or merchant computer system 110. Merchant computer system 110 may receive data from at least one source, including one or more customer or cardholder personal computing devices (e.g. a mobile phone) 132, AVS 120, payment network systems 130, and card issuer systems 140.

In one embodiment, a customer or potential customer, may download a merchant-specific, software-based application onto their personal computing device 132. As known in the art, these types of applications may be specifically-configured for operation on mobile devices, and may provide a customer with the ability to make purchases, browse products, check order statuses, and the like, without having to navigate to a merchant's internet-based website. The application may be downloaded to, or otherwise stored on, the customer's device for execution through any conventional means. For example, a customer may access a web-based application (e.g. a website) running on merchant computer system 110 or another remote server via their device. The web-based application may include executable instructions for downloading the application onto the device for future use.

Once downloaded and launched, the application may be configured to prompt a customer to enter identification information, such as their first and last name. If the customer is using the application for the first time, this step may include generating an account and assigning a username and a password to the customer, wherein subsequent customer application sessions may require a log-in which associates any data generated during the session with their account. The application may also prompt a customer to enter payment card information, such as a payment card number only, as well as a mobile phone number (e.g. the number of the mobile phone they are using to access the application). Information entered by the customer, as well as the date and time at which they were entered may be stored within a memory of device 132.

The application is further configured to determine or capture the geographical position of the customer's mobile phone. In one embodiment, this step may include interfacing with the phone's on-board GPS system for determining its geolocation (e.g. latitude and longitude coordinates). The step of determining mobile phone geolocation data may be done automatically by the application, or in response to a request initiated by, for example, merchant computer system 110, at one or more predetermined times. In one embodiment, the date and time of the generation of geolocation information may also be captured and stored into the memory of personal computing device 132.

The application may be configured to transmit the captured geolocation data, customer identification data, payment card data, and date and time data associated the capturing of geolocation data to merchant computer system 110 via, for example a network 150 accessible through a wireless data connection of personal computing device 132 (e.g. a cellular phone data network). Network 150 can be virtually any form or mixture of networks consistent with embodiments as described herein including, but not limited to, telecommunication or telephone lines, the Internet, an intranet, a local area network (LAN), a wide area network (WAN), virtual private network (VPN) and/or a wireless connection using radio frequency (RF) and/or infrared (IR) transmission to name a few.

The application may be configured to periodically capture and transmit updated geolocation data associated with device 132, as well as a date and time associated with each captured geolocation. In one embodiment, the application may poll the customer's device for geolocation data at a predetermined time (e.g. 3:00 AM), and may repeat the steps of generating geolocation data and associated date and time of the generation, as well as the transmission of said data to merchant computer system 110. This data may be stored on a geolocation database 155. In this way, a historic record of the location of the customer's device may be generated and used to estimate an address characteristic of the cardholder (e.g. a billing postal code).

Merchant computer system 110 is programmed to receive customer identification data, payment card data, phone number data, as well as geolocation data generated by device 132. Once received, this data may be processed, including the steps of identifying, classifying and storing the received data. For example, geolocation data may be identified and classified accordingly. This may include identifying the format in which the geolocation data has been transmitted and/or received. Received and identified geolocation data may be normalized, or converted, to any suitable standard format. Normalized geolocation data, customer identification data, payment card data, phone number data, and date and time data may be stored in database 155.

As set forth above, merchant computer system 110 may utilize address characteristics estimated from this geolocation data to verify a payment card billing address via the AVS 120. More specifically, merchant computer system 110 may generate a standard authorization message or request (e.g. on a real-time or batch mode basis), including a payment card number and estimated address characteristic for transmission to AVS 120. As will be understood by one of ordinary skill in the art, this authorization message may flow from the merchant computer system 110, to an acquiring bank associated with the payment card, as well as through associated payment network systems 130 and card issuer systems 140 for processing by AVS 120. Once in receipt of this information, AVS 120 may verify a known billing address of the payment card against the estimated address characteristic supplied with the authorization message via communications with the associated card issuer systems 140. Specifically, the billing address of the payment card may be stored in a database 145 accessible via a card issuing systems 140, and compared to the address characteristic included on the authorization message. As further described above, several variations to this method are envisioned. For example, in one embodiment, payment network system 130 may be responsive to geolocation data stored in database 155 supplied by merchant computer system 110, or a third party provider. Payment network system 130 may be tasked with estimating the address characteristic and initiating AVS processing.

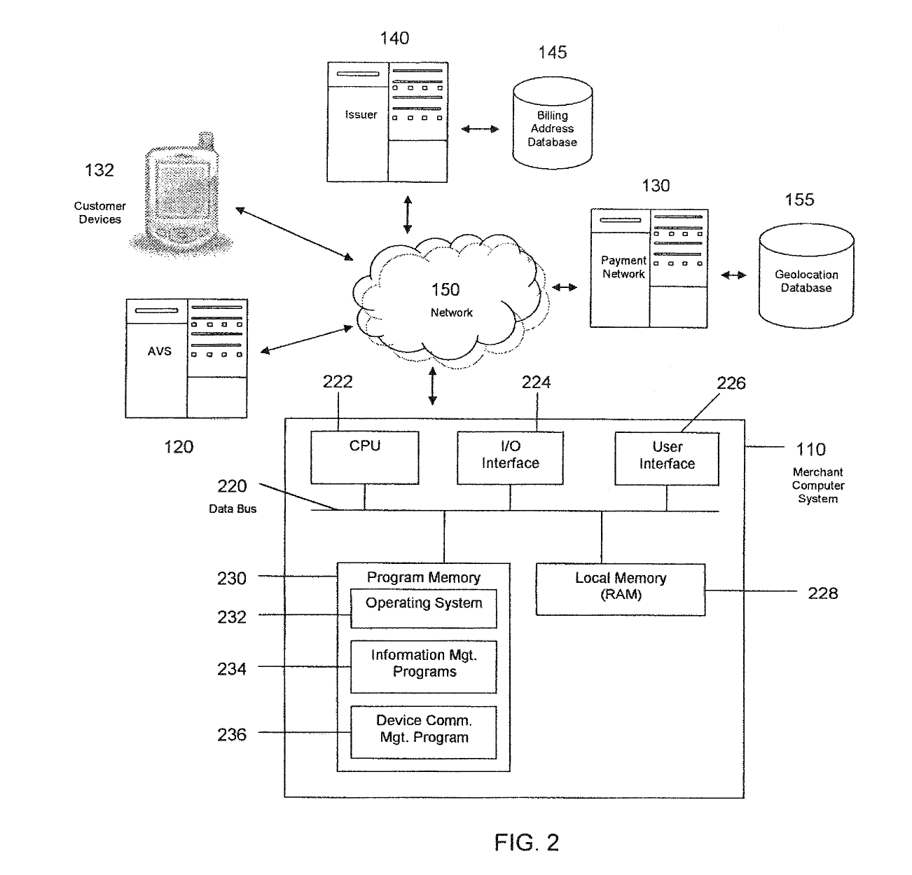

Referring now to FIG. 2, a more detailed embodiment of an exemplary managing or merchant computer system 110 as described above with respect to FIG. 1 is shown. Merchant computer system 110 includes a data bus 220 providing communication among system components. One or more computer processors, designated by central processing unit (CPU) 222, is in communication via data bus 220 with components including program memory 230, local memory 228, user interface 226, and input/output interface 224. Program memory 230 stores programs including an operating system (OS) 232, which manages the computer hardware and provides common services for efficient execution of various logic circuitry including hardware, software and/or programs. Program memory 230 further stores one or more programs 234, which include computer-executable instructions to execute rules to perform the processing described herein, such as the requests for payment card data and geolocation data, identification and classification of received data, the normalization of geolocation data, as well as other control communications between the management computer system and external devices. Managing or merchant computer system 110 further includes device communication management program 236, which includes computer-executable instructions to manage communications, including communications of data to and from customer devices and external databases. The processor 222 (or CPU) carries out the instructions of computer programs, which operates and/or controls at least a portion of the functionality of merchant computer system 110. Program instructions may be loaded into local memory 228 for efficient and high-speed execution by CPU 222. Programs may be arranged in one or more modules, and functionality of programs may be implemented in program code that may be arranged as one or more programs or modules, which need not be stored on a same memory device, or executed by a single CPU.

Merchant computer system 110 further includes a device input/output interface 224 configured to receive and output data and information to and/or from merchant computer system 110 from and/or to peripheral devices and networks operatively coupled to the system. Such networks may include exemplary network 150, which manages communications among, for example, customer devices 132, AVS 120, card issuer systems 140, and payment network systems 130. The I/O interface 224 may include a query interface configured to accept and parse requests of customer devices 132 and any external systems and pass those requests to CPU 222 for processing using instructions of device communication management program 236.

The program memory 230 may include one or more of any form of data storage device including but not limited to electronic, magnetic, optical recording mechanisms, combinations thereof or any other form of memory device capable of storing data. The CPU 222 may be in the form of one or more computer processors, or may be in such forms as a distributed computing system, a centralized computing system, a network server with communication modules and other processors, or nearly any other automated information processing system capable of executing instructions stored in program memory. Merchant computer system 110 may be embodied as a data warehouse or repository for storing, managing and processing volumes geolocation data received from a variety of sources on a periodic or continuous basis.

Each or any combination of the modules and components shown in FIGS. 1 and 2 may be implemented as one or more software modules or objects, one or more specific-purpose processor elements, or as combinations thereof. Suitable software modules include, by way of example, an executable program, a function, a method call, a procedure, a routine or sub-routine, one or more processor-executable instructions, an object, or a data structure.

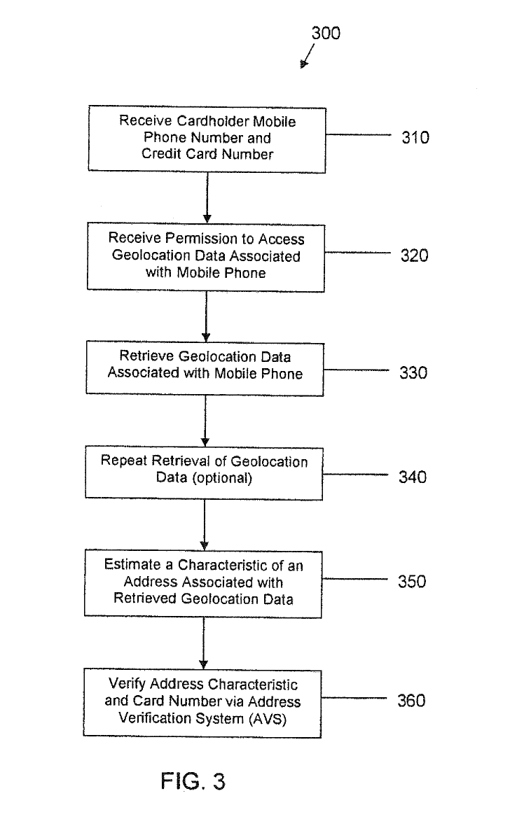

Referring now to FIG. 3, there is shown an exemplary process flow diagram of a method 300 for acquiring and verifying a characteristic of a billing address of a payment card according to an embodiment of the present disclosure. A merchant computer system is responsive to receive 310, for example, a mobile phone number and a payment card number entered by a cardholder. This may be achieved through a merchant website interface or via a merchant-specific application running on a personal computing device of a cardholder. The merchant computer system is also configured to receive 320, for example, in response to an inquiry generated by the system, permission from the cardholder for accessing geolocation data associated with their mobile phone. Once received, the merchant computer system may retrieve or capture 330 and store geolocation data associated with the cardholder's mobile phone. This geolocation data may include data acquired from a GPS system of the mobile phone at one or more predetermined times after the permission to access such data had been granted. This process may be repeated 340 in order to generate a plurality of geolocation data points for the mobile device. Along with the geolocation data, the merchant computer system may also receive and store the time at which the geolocation data was captured. From the geolocation data, a characteristic of an address (e.g. a postal code, street address, etc.) associated with the geolocation is estimated 350. This process may include performing reverse geocoding operations. Once an address characteristic has been estimated, the merchant computer system may attempt to verify 360 the payment card number and estimated address characteristic through the AVS. In embodiments, this may be achieved prior to any purchase by the cardholder via an ASI, or post-purchase via a traditional authorization message.

While the above method is described in the context of a merchant computer system performing each of the steps of the embodiment, it should be understood that some of the steps described therein may be performed by systems of third party providers, or other remote systems. For example, the merchant computer system may outsource the retrieval of mobile phone geolocation data to existing systems configured to collect such data. Moreover, it should be understood that in embodiments wherein a cardholder is utilizing an application running on their personal computing device, the application may be configured to generate, store and/or transmit geolocation data without requiring the cardholder to provide a mobile phone number.

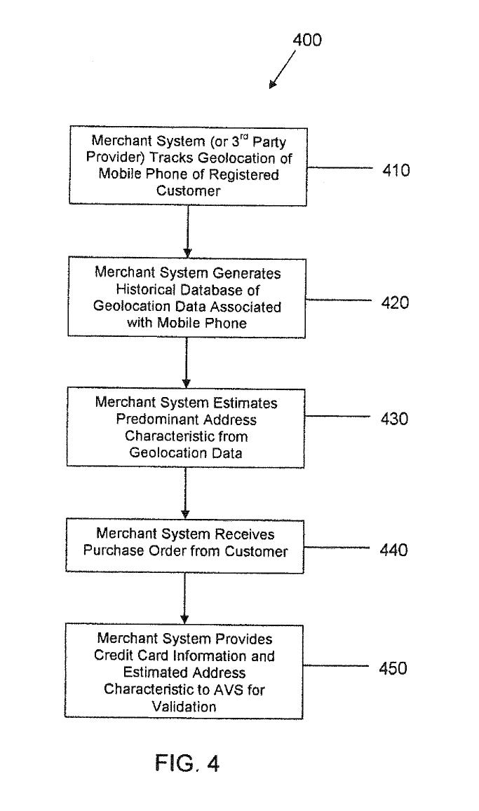

Referring generally to FIG. 4, another exemplary process flow diagram is shown of a method 400 for acquiring and verifying a characteristic of a billing address of a payment card. A merchant computer system, or an outside service provider, tracks 410 the geolocation of a mobile phone of a customer registered with the merchant. This tracking may include, but is not limited to, requesting geolocation data from the mobile device periodically. These requests may be made at a predetermined time or interval, and over a predetermined duration. In one embodiment, the requests are made at a time when the customer is likely to be at their residence (e.g. in the early morning hours). From this data, a merchant computer system, or an outside provider, generates 420 a historic database of geolocation data associated with the mobile device. This database may be used to estimate 430 an address characteristic that appears to coincide with the customer's or cardholder's residence. For example, historic analysis made be performed on the database to identify a geolocation that appears to coincide with a customer being at their home (residence). An address characteristic (e.g. a postal code) may be determined from this identified geolocation by, for example, reverse geocoding methods. Subsequent customer purchases may be received 440 by the merchant computer system for processing and fulfillment. The merchant computer system may provide 450 the customer's payment card information, along with the estimated address characteristic (e.g. the postal code inferred from the geolocation data), to the AVS for validation in a conventional way.

Embodiments of the present disclosure include systems and methods for acquiring and identifying relevant geolocation data prior to the purchase of any goods or services, wherein this data may be used immediately upon receipt of an order to begin the payment card validation processing. This is distinct from other embodiments of the present disclosure, which may track mobile phone geolocation data only after a purchase had been made.

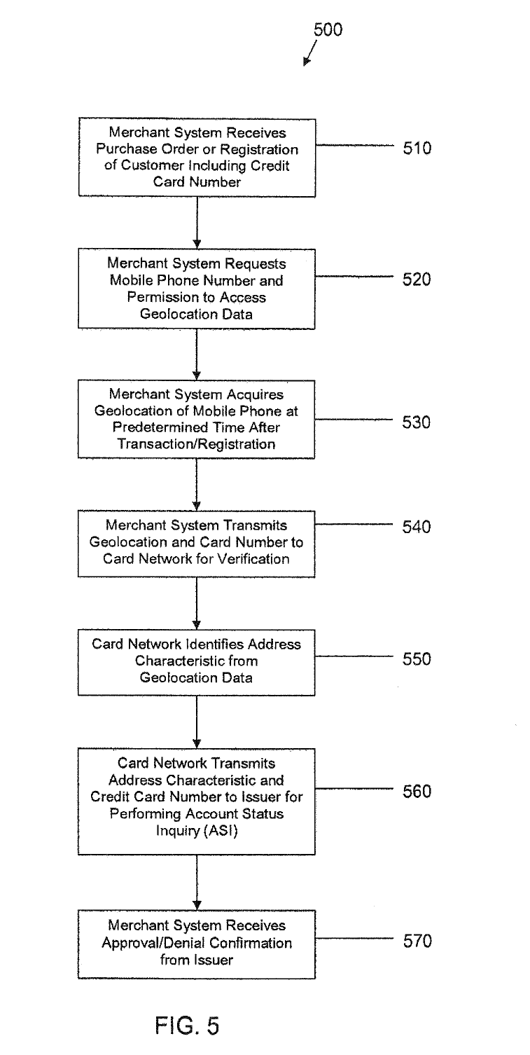

Referring generally to FIG. 5, an exemplary process flow diagram is shown of another method 500 for acquiring and verifying a characteristic of a billing address of a payment cardholder according to an embodiment of the present disclosure. In the exemplary method, a merchant computer system receives 510 payment card information (e.g. a payment card number) from an existing or potential customer. This information may be generated from a new purchase order received from a customer, or from a new customer account registration (e.g. a customer installing a merchant application on their mobile phone and inputting their payment card information for future transactions). In response to receiving the customer payment card information, the merchant computer system requests 520 a mobile phone number of the cardholder, as well as permission to access geolocation data associated with the phone. At any time after receiving permission, the merchant computer system may acquire 530 the geolocation of the customer's mobile phone one or more times. This step may include the use of outside service providers to gather the geolocation data. In the illustrated embodiment, the merchant computer system may transmit 540 the payment card number and geolocation to a card network (e.g. MasterCard network) associated with the payment card. The card network may, either internally or through outside resources, identify 550 an address characteristic (e.g. a postal code) from the geolocation data. It should also be understood that in other embodiments, the merchant computer system may perform this step. The card network may transmit 560 this address characteristic and the payment card number to the payment card issuer (e.g. an issuing bank), for performing an ASI. The merchant computer system receives 570 the results of the ASI, including either an approval or decline from the issuer. In this way, embodiments of the present disclosure include systems and methods for determining the validity of an address characteristic prior to the occurrence of a purchase transaction. Accordingly, payment card denials for address-related deficiencies can be preemptively avoided.

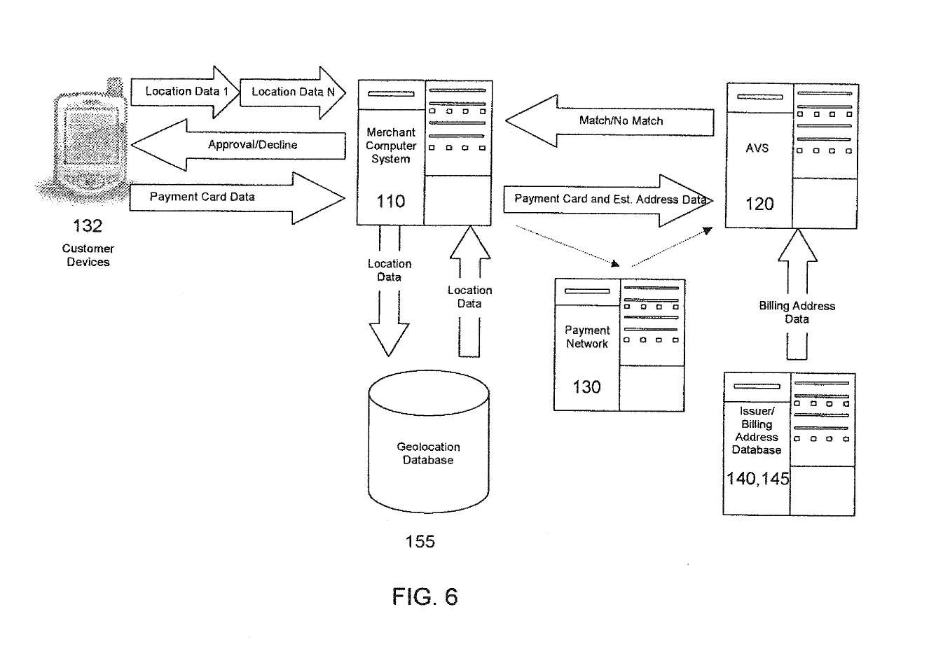

Referring to FIG. 6, an exemplary data flow diagram for acquiring and verifying a characteristic of a billing address of a payment card or payment account according to an embodiment of the present disclosure is provided. A remote server embodied as a managing or merchant computer system 110 is configured to receive data from at least one source, including one or more customer or cardholder personal computing devices (e.g. a mobile phone) 132, AVS 120, and payment network systems 130.

Customer personal computing device 132 may be configured to transmit geolocation data at a plurality of intervals (embodied herein as Location Data 1-N), customer identification data, payment card data, and date and time data associated with the capturing of geolocation data to merchant computer system 110 via, for example a network accessible through a wireless data connection of customer device 132. Once received, merchant computer system 110 may store this data on geolocation database 155 for generating a record of the location of the customer's device and subsequently estimating an address characteristic of the cardholder.

As set forth above, merchant computer system 110 may utilize address characteristics estimated from this geolocation data to verify a payment card billing address via the AVS 120. Merchant computer system 110 may generate a standard authorization message or request, including a payment card number and an estimated address characteristic for transmission to AVS 120. The authorization message may flow from the merchant computer system 110, to an acquiring bank associated with the payment card, as well as through associated payment network system 130 for processing by AVS 120. Once in receipt of this information, AVS 120 may verify a known billing address of the payment card against the estimated address characteristic supplied with the authorization message via communications with the associated card issuer systems 140. Specifically, the billing address of the payment card may be stored in a database 145 accessible via a card issuer system 140, and compared to the address characteristic included on the authorization message. AVS 120 may return an indication of the results of the above-described billing address comparison via an authorization response. Merchant computer system 110 may in-turn generate an approval or decline response for providing to customer device 132.

The flow charts described herein do not imply a fixed order to the steps, and embodiments of the present invention may be practiced in any order that is practicable. In embodiments, one or more steps of the methods may be omitted, and one or more additional steps interpolated between described steps. Note that any of the methods described herein may be performed by hardware, software, or any combination of these approaches. For example, a non-transitory computer-readable storage medium may store thereon instructions that when executed by a processor result in performance according to any of the embodiments described herein. In embodiments, each of the steps of the methods may be performed by a single computer processor or CPU, or performance of the steps may be distributed among two or more computer processors or CPU's of two or more computer systems. In embodiments, each of the steps of the methods described with reference to FIGS. 3-5 may be performed by an applications processing unit (APU), which may include one or more processors. In embodiments, one or more steps of a method may be performed manually, and/or manual verification, modification or review of a result of one or more processor-performed steps may be required in processing of a method.

The embodiments described herein are solely for the purpose of illustration. Those in the art will recognize that other embodiments may be practiced with modifications and alterations limited only by the claims.

What is claimed is:

1. A system for verifying a characteristic of a billing address of a payment card for use in computer network based financial transactions, the system comprising:
one or more processors;
a memory in communication with the one or more processors and storing program instructions, the one or more processors operative with the program instructions to:
receive data indicative of a payment card number from a cardholder;
receive permission to access geolocation data associated with a personal computing device of the cardholder;
request geolocation data associated with the personal computing device at a predetermined future time;
receive the requested geolocation data;
estimate a characteristic of an address associated with the geolocation data; and
provide the estimated address characteristic and the payment card number to an address verification system for verifying the validity of the characteristic of the address.

2. The system of claim 1, wherein the personal computing device of the cardholder is a mobile phone, and wherein the one or more processors is operative with the program instructions to receive a mobile phone number data associated with the mobile phone.

3. The system of claim 1, wherein the characteristic of the address estimated from the geolocation data is a postal code.

4. The system of claim 1, wherein the step of estimating the characteristic of the address from the geolocation data includes performing a reverse geocoding operation.

5. The system of claim 1, wherein the step of requesting geolocation data associated with the personal computing device is repeated at a predetermined interval.

6. The system of claim 5, wherein the one or more processors is operative with the program instructions to generate a historical database comprising geolocation data received from the personal computing device.

7. A computer implemented method for verifying a characteristic of a billing address of a payment card for use in computer network based financial transactions, the method comprising:
receiving payment card number data from a cardholder;
receiving permission to access geolocation data associated with a personal computing device of the cardholder;
requesting geolocation data associated with the personal computing device at a predetermined future time;
receiving the requested geolocation data;
estimating a characteristic of an address associated with the geolocation data; and
submitting the estimated address characteristic to an address verification system for verifying the validity of the characteristic of the address.

8. The method of claim 7, wherein the personal computing device comprises a mobile phone, and wherein the method further comprises receiving a mobile phone number data associated with the mobile phone.

9. The method of claim 7, wherein the characteristic of the address estimated from the geolocation data is a postal code.

10. The method of claim 7, wherein the step of estimating the characteristic of the address from the geolocation data includes performing a reverse geocoding operation.

11. The method of claim 7, wherein the step of requesting geolocation data associated with the personal computing device is repeated at a predetermined interval.

12. The method of claim 11, further comprising the step generating a historical database comprising geolocation data received from the personal computing device.

13. A computer implemented method for verifying a characteristic of a billing address of a payment card, the method comprising:
periodically determining a geolocation of personal computing device associated with a payment card holder;
generating a historic database of the determined geolocation data;
analyzing the database to estimate an address characteristic from the geolocation data;
submitting the estimated address characteristic to an address verification system.

14. The method of claim 13, wherein the personal computing device comprises a mobile phone.

15. The method of claim 13, wherein the address characteristic estimated from the geolocation data is a postal code.

16. The method of claim 13, wherein the step of analyzing the database to estimate the address characteristic from the geolocation data includes performing a reverse geocoding operation.

17. A computer system of a payment card network system for verifying a characteristic of a billing address of a payment card, the system comprising:
one or more processors;
a memory in communication with the one or more processors and storing program instructions, the one or more processors operative with the program instructions to:
receive a payment card number from a merchant;
receiving geolocation data associated with a personal computing device of a customer;
identify an address characteristic from the geolocation of the personal computing device; and
transmit the address characteristic and the payment card number to a payment card issuer associated with the payment card for performing an account status inquiry.

18. The system of claim 17, wherein the personal computing device comprises a mobile phone.

19. The system of claim 17, wherein the address characteristic estimated from the geolocation data is a postal code.

20. The system of claim 17, wherein the step of identifying the address characteristic from the geolocation data includes performing a reverse geocoding operation.
